(19) United States
(12) Patent Application Publication
(10) Pub. No.: US 2016/0348044 A1
(43) Pub. Date: Dec. 1, 2016

(54) PROCESS FOR MAKING A SINGLE OR MULTI-COMPARTMENT POUCH

(71) Applicant: The Procter & Gamble Company, Cincinnati, OH (US)

(72) Inventors: David John SMITH, Newcastle upon Tyne (GB); Philip Frank SOUTER, Northumberland (GB); Alan Thomas BROOKER, Newcastle upon Tyne (GB); Nigel Patrick SOMERVILLE ROBERTS, Newcastle upon Tyne (GB)

(21) Appl. No.: 15/154,043

(22) Filed: May 13, 2016

(30) Foreign Application Priority Data
May 29, 2015 (EP) 15169973.3

(51) Int. Cl. C11D 17/04; B65B 3/04; B65D 65/46; B65B 7/02; B65B 1/04

(52) U.S. Cl. CPC C11D 17/045; C11D 17/043; C11D 17/044; B65B 7/02; B65B 1/04; B65D 65/46; B65B 3/04

(57) ABSTRACT

A process for making a single or multi-compartment water-soluble cleaning pouch, the pouch comprising an enveloping material and a detergent composition, the detergent composition comprising a cohesive powder and having a low pH, the process comprising the steps of: i) making a first open compartment and filling the first open compartment with a homogeneous free-flowing powder comprising the cohesive powder in the form of a secondary particle wherein at least 80% of the homogeneous free-flowing powder has a weight average particle size of from about 250 to about 850 μm with less than about 10% by weight of the particles below about 150 μm and less than about 5% by weight of the particles above about 1180 μm and wherein the powder has a cake strength of less than about 20 N; ii) optionally making a second open compartment and filing the second open compartment with a liquid; and iii) closing the open compartment(s) to make a pouch.

### TECHNICAL FIELD

The present invention is in the field of cleaning, in particular it relates to a process for making a water-soluble single or multi-compartment cleaning pouch. The pouch comprises a compartment comprising a homogenous free-flowing powder and optionally a compartment comprising a liquid composition. The powder comprises a cohesive powder in the form of a secondary particle, preferably in the form of agglomerate. The pouch is extremely well suited for use in automatic dishwashing.

### BACKGROUND OF THE INVENTION

Water-soluble cleaning pouches, such as laundry and automatic dishwashing cleaning pouches, usually contain alkaline compositions. It has been found that low pH compositions, in particular automatic dishwashing low pH compositions, can be very good for cleaning, shine and care. Particularly useful can be low pH compositions comprising an iron chelant. However, iron chelants are usually synthesized in the form of very fine powder. Fine powder can be difficult to process when used in formulations with powders of different granulometry. Fine powders used in cleaning pouches can give rise to segregation and lack of flowability issues. Fine powders might not only present handling issues but they might also present dissolution issues in use.

Very good multi-compartment pouches can be obtained when the pouch further comprises a compartment comprising a liquid composition. Multi-compartment pouches with a compartment comprising a powder composition and a compartment comprising a liquid composition provide great formulation flexibility and allow for the use of most detergent ingredients in their original physical forms. They also contribute to minimize the volume occupied by the composition.

Pouches comprising lime soap dispersing agents have been found to be very good in terms of cleaning. The processing of low pH lime soap dispersing agents containing products can be challenging, in particular when the cleaning composition is in the form of a water-soluble pouch. Lime soap dispersing agents are usually synthesized in aqueous solution. Aqueous compositions can be incompatible with the water-soluble materials which envelop the cleaning composition to form the pouch. The lime soap dispersing agent resulting from drying the aqueous solution can be sticky thereby negatively impacting the processability and stability of the cleaning composition. Zeolites and other insoluble inorganic materials can be used as processing aids for lime soap dispersing agents, however, products containing zeolites or other insoluble inorganic materials may not be suitable for use in automatic dishwashing because they could leave residues on the washed items. Carbonates can also be used as processing aids, however carbonates are alkaline and if they were to be used in low pH compositions a neutralizing agent would be necessary. This may not be desirable due to the volume constrains to which pouches are subjected. Automatic dishwashing pouches are usually small (around 5-25 grams) so they can fit in the dishwasher dispenser therefore, it is important that the cleaning actives occupy as little volume as possible, thus it is not desirable to have inactives in which the active cleaning ingredients are loaded, it is desirable to have only cleaning actives in the pouch.

Yet, a further consideration during the manufacture of pouches is the speed of production. Low speed may result in a non-economically viable process. Due to the small size of the pouches the composition to be fed into the different compartments should be highly flowable to be delivered in a fast manner.

The objective of the present invention is to provide a low variability and efficient process for making low pH water-soluble pouches. The pouches obtained by the process should be storage stable and the cleaning composition should dissolve fast.

### SUMMARY OF THE INVENTION

According to a first aspect of the invention, there is provided a process for making a single or multi-compartment water-soluble cleaning pouch, i.e. a pouch containing a cleaning composition, preferably an automatic dishwashing detergent composition. The pouch can have a single or a plurality of compartments. The pouch comprises an enveloping material holding a detergent composition. Sometimes the detergent composition in the pouch made according to the process of the invention is herein referred to as “the composition of the invention”. Preferably, the pouch is an automatic dishwashing pouch, more preferably a multi-compartment automatic dishwashing pouch.

The composition of the invention has a “low pH”. In addition to good cleaning and shine in automatic-dishwashing, this pH is quite gentle on the washed items, it is not as aggressive as commonly used alkaline compositions and therefore keep washed items such as glasses, patterned ware, etc looking new for longer. In terms of process the low pH requirement imposes some restriction. Materials that are alkaline should not be used in the composition of the invention.

The composition of the invention comprises a cohesive powder. Cohesive powers tend to stick together. They negatively impact on the flowability of the detergent powder and the dissolution of the product. The cohesive powder of the composition of the invention is in the form of a secondary particle, preferably in the form of an agglomerate, this overcomes the lack of flowability and the potential dissolution issues.

The process of the invention comprises the steps of:
i) making a first open compartment and filling the first open compartment with a homogeneous free-flowing powder, the homogeneous free-flowing powder comprises a cohesive powder in the form of a secondary particle. At least 80% of the homogeneous free-flowing powder has a weight average particle size of from about 250 to about 850 μm with less than about 10% by weight of the particles below about 150 μm and less than about 5% by weight of the particles above about 1180 μm. The powder is free-flowing and has a cake strength of less than about 20 N;
ii) optionally, but preferably, making a second open compartment and filing the second open compartment with a liquid; and
iii) closing the open compartment(s) to make a pouch.

The homogeneous free-flowing powder of the composition of the invention allows for fast filling of the first open compartment thereby contributing to the speed of the process for making the pouches. The powder is easy to handle and it does not present segregation or clumping issues.

Preferably, the cohesive powder is an iron chelant. Low pH automatic dishwashing compositions comprising an iron chelant have been found to provide very good cleaning. The processing of cohesive powders can be challenging, the cohesive powder, if used as it is, negatively impact the flowablility of the detergent powder. Cohesive powders when granulated can present dispersion and/or dissolution issues. It has now been found that very good powder flowability and dissolution is obtained when the cohesive powder is in the form of an agglomerate. Preferably the agglomerate comprises a highly water-soluble salt. The highly water-soluble salt helps dispersing, and thereby dissolving, the cohesive powder. The preferred highly water-soluble salt for use herein is citrate, more preferably sodium citrate. Citrate not only contributes to the dispersion of the cohesive powder but also contributes to the cleaning by providing low pH and acting as a pH buffer for the detergent composition.

Compositions comprising an iron chelant provide good cleaning of bleachable stains, even in the absence of bleach or with low level of bleach. Without being bound by theory, it is believed that the iron chelant removes heavy metals that form part of bleachable stains, thereby contributing to the loosening of the stain. The stain tends to detach itself from the soiled substrate. The cleaning can be further helped by the presence of a performance polymer, preferably a dispersing polymer that would help with the suspension of the stain. Under the low pH conditions provided by the compositions of the invention, when the heavy metals are taken from the bleachable stain, the stain can become more particulate in nature and the polymer can help with suspension of the stain. Preferred iron chelants for use herein have been found to be disodium catecholdisulfonate and hydroxypyridine N-Oxides, in particular disodium catecholdisulfonate.

It has been found that an agglomerate with good physical characteristics and a good dissolution profile can be obtained when highly water-soluble salt of two different particle sizes are used.

Another advantage when using a salt of two different particle sizes is that less water is required to form the agglomerate and therefore less drying is required, making the process more energy efficient.

Preferably, the pouch comprises a second compartment comprising a liquid composition, more preferably the liquid comprises a lime soap dispersing agent. Pouches comprising a liquid and solid comprising compartments have been found extremely efficient in terms of space, i.e., very compact products can be obtained that provide very good cleaning performance. The process of the invention is extremely fast due to the flowability of the powder composition and the physical characteristic of the liquid composition.

Preferably, the liquid composition comprises a lime soap dispersing agent. Lime soap dispersing agents are usually synthesized in aqueous solutions. Usually the aqueous solutions comprising lime soap dispersing agents are alkaline, if the pH is too high (greater than 10) cross-linking of the enveloping material, usually made of polyvinyl alcohol, might occur thereby impacting on the solubility of the pouch. Preferably, the liquid composition comprises a neutralising agent to bring the pH of the composition below 10. Preferred neutralising agent for use herein is sodium citrate. A liquid composition has more effect on the cross-linking of the enveloping material than a solid composition. The water brought into the liquid composition in the lime soap aqueous solution needs to be managed so it does not interact with the water-soluble enveloping material. Also phase separation of the liquid composition needs to be avoided. It has been found that a liquid composition stable when in contact with the water-soluble material is obtained when the liquid comprises glycerine and preferably dipropylene glycol. In particular liquid compositions in which the lime soap dispersing agent and glycerine are in a weight ratio of from about 3:1 to about 1:1 have been found very stable. Compositions in which the lime soap dispersing agent and dipropylene glycol are in a weight ratio of from about 4:1 to about 2:1 have also been found very stable. Especially preferred from a stability viewpoint are compositions in which the lime soap dispersing agent and the dipropylene glycol are in a weight ratio of from about 4:1 to about 2:1 and the lime soap dispersing agent and the glycerine are in a weight ratio of from about 3:1 to about 1:1. Preferably, the liquid composition comprises at least 20% by weight of the liquid of an aqueous lime soap dispersing agent and has a pH of less than 10. The liquid preferably has a viscosity of from about 1 to about 500 mPa s at 23° C. Preferably, the liquid has an eRH of less than about 60%, more preferably less than 55% at 20° C. Compositions having this eRH are highly compatible with the enveloping material.

By “aqueous lime soap dispersing agent” is herein meant an aqueous solution comprising a lime soap dispersing agent, the solution comprises more than 10%, preferably more than 15%, preferably less than 50%, more preferably less than 40% by weight of the solution of water.

The lime soap dispersing agent preferably provides swelling of the soil, in particular greasy soils. The composition of the invention preferably comprises an amylase, more preferably a low temperature amylase. It seems that the amylase and the lime soap dispersant agent work in synergy to provide very good cleaning and shine. Without being bound by theory it is believed that the lime soap dispersing agent keeps the soil, especially greasy soils, suspended leaving the starchy part of soils exposed this facilitate the access of the amylase to the starch. Preferred lime soap dispersing agents for use herein are surfactants, preferably anionic surfactants, especially an alkyl ethoxy sulfate and/or performance polymers, preferably dispersant polymer especially an alkoxylated polyalkyleneimine.

Preferably, the composition of the invention is “substantially builder-free”. For the purpose of this invention a “substantially builder-free composition” is a composition comprising less than 10%, preferably less than 5%, more preferably less than 1% and especially less than 0.1% by weight of the composition of builder. Builders are cleaning actives widely used in automatic dishwashing detergents, in particular in alkaline compositions. Most, if not all, of the automatic dishwashing detergents available in the market are alkaline and comprise builders. Compounds that would act as builder under alkaline conditions would probably not be good builders under the low pH conditions of the composition of the invention. Builders can sequester calcium and other ions, from soils and from water greatly contributing to cleaning. The downside of using builders is that they can precipitate and give rise to filming and spotting on the washed items.

The formulation approach used in the composition of the present invention overcomes the filming and spotting issues. The washed items, in particular, glass items are left clear and shiny.

The soils brought into the wash liquor during the automatic dishwashing process can greatly alter the pH of the wash liquor. In order to provide optimum cleaning the pH of the wash liquor should not vary too much. This is achieved with the composition of the present invention by the presence of a buffer that helps to keep the pH of the wash liquor within a desired range.

The composition of the invention comprises a buffer. By “buffer” is herein meant an agent that when present in a wash liquor is capable of maintaining the pH of the liquor within a narrow range. By a “narrow range” is herein meant that the pH changes by less than 2 pH units, more preferably by less than 1 pH unit.

Preferably the buffer comprises an organic acid, preferably a carboxylic acid and more preferably the buffer is selected from a polycarboxylic acid, its salt and mixtures thereof.

It has also been found that small levels of bleach in the composition of the invention provide a level of bleaching much greater than expected. It has also been found that the bleaching occurs faster and at lower temperatures than using conventional alkaline detergents.

Without being bound by theory, it is believed that the iron ions present into the wash liquor (brought by soils, such as tea, beef, etc., impurities in detergent components and/or water) act as catalyst for the bleach to generate bleaching radicals. This effect is most pronounced when an iron chelant is used and it is believed that this is the case because the iron chelant binds the iron to generate metal catalysts in situ that when combined with the bleach are able to drive excellent bleach cleaning.

The cleaning provided by the compositions of the invention is further improved when the composition comprises a crystal growth inhibitor, in particular HEDP.

The performance provided by the compositions of the invention is further improved by anionic surfactant, when the composition comprises anionic surfactant, the use of a suds suppressor is preferred. Anionic surfactants can generate suds during the automatic dishwashing process however the suds generation with the composition of the invention is less that the suds generation under alkaline conditions, thus the level of suds suppressor required is lower than what it would be for an alkaline composition.

Preferred compositions further comprise proteases. In particular proteases selected from the group consisting of:
(i) a metalloprotease;
(ii) a cysteine protease;
(iii) a neutral serine protease;
(iv) an aspartate protease, and
(v) mixtures thereof.

These proteases perform well in the low pH composition of the invention. Some of the proteases present in conventional alkaline detergents do not perform well at the pH of the composition of the invention. Also preferred are endoproteases, preferably those with an isoelectric point of from about 4 to about 9 and more preferably from about 4.5 to about 6.5. Compositions comprising proteases having these isoelectric points perform very well in the low pH compositions of the invention.

The compositions of the invention is so effective that only a low level needs to be used in the dishwasher to provide outstanding results thereby allowing for very compact pouches. The pouch of the invention preferably has a weight of from about 5 to about 25 grams, more preferably from about 7 to about 20 grams and especially from about 7 to about 15 grams. The pouch of the invention comprises a water-soluble material enveloping the composition of the invention, preferably a polyvinyl alcohol film.

According to a second aspect of the invention, there is provided a single or multi-compartment water-soluble detergent pouch. The pouch provides good cleaning and it is produced in a very efficient way.

The elements of the composition of the invention described in connexion with the first aspect of the invention apply mutatis mutandis to the second aspect of the invention.

### DETAILED DESCRIPTION OF THE INVENTION

The present invention envisages a process for making a single or multi-compartment water-soluble cleaning pouch, preferably an automatic-dishwashing pouch, more preferably a multi-compartment automatic-dishwashing pouch. The process is fast, reliable, has low variability and allows for the manufacture of compact pouches. There is also provided a pouch produced by the process of the invention. The pouch is compact and provides good cleaning, shine and care.

### Water-Soluble-Pouch

A water-soluble cleaning pouch is a pouch containing a cleaning composition, preferably an automatic dishwashing or laundry detergent composition, and an enveloping material. The enveloping material is water-soluble and preferably it is a water-soluble film. Both the cleaning composition and the enveloping material are water-soluble. They readily dissolve when exposed to water in an automatic dishwashing or laundry process, preferably during the main wash. The pouch can have a single compartment or a plurality of compartments (multi-compartment pouch).

By “multi-compartment pouch” is herein meant a pouch having at least two compartments, preferably at least three compartments, each compartment contains a composition surrounded by enveloping material. The compartments can be in any geometrical disposition. The different compartments can be adjacent to one another, preferably in contact with one another. Especially preferred configurations for use herein include superposed compartments (i.e. one above the other), side-by-side compartments, etc. Especially preferred from a view point of automatic dishwasher dispenser fit and enveloping material reduction are multi-compartment pouches having some superposed compartments and some side-by-side compartments.

Preferably the pouch weight is from about 5 to about 25 grams, this makes it suitable for being placed in the dispenser of an automatic dishwasher.

### Enveloping Material

The enveloping material is water soluble. By “water-soluble” is herein meant that the material has a water-solubility of at least 50%, preferably at least 75% or even at least 95%, as measured by the method set out herein after using a glass-filter with a maximum pore size of 20 microns. 50 grams+−0.1 gram of enveloping material is added in a pre-weighed 400 ml beaker and 245 ml+−1 ml of distilled water is added. This is stirred vigorously on a magnetic stirrer set at 600 rpm, for 30 minutes at 20° C. Then, the mixture is filtered through a folded qualitative sintered-glass filter with a pore size as defined above (max, 20 micron). The water is dried off from the collected filtrate by any conventional method, and the weight of the remaining material is determined (which is the dissolved or dispersed faction). Then, the % solubility can be calculated.

The enveloping material is any water-soluble material capable of enclosing the cleaning composition of the product of the invention. The enveloping material can be a polymer that has been injection moulded to provide a casing or it can be a film. Preferably the enveloping material is made of polyvinyl alcohol. Preferably the enveloping material is a water-soluble polyvinyl alcohol film.

The pouch can, for example, be obtained by injection moulding or by creating compartments using a film. The enveloping material is usually moisture permeable. The pouch of the invention is stable even when the enveloping material is moisture permeable. The liquid composition confers stability to the pouch, in terms of both interaction among the different compositions and interaction with the surrounding environment. Preferred substances for making the enveloping material include polymers, copolymers or derivatives thereof selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Especially preferred for use herein is polyvinyl alcohol and even more preferred polyvinyl alcohol films.

Most preferred enveloping materials are PVA films known under the trade reference Monosol M8630, as sold by Kuraray, and PVA films of corresponding solubility and deformability characteristics. Other films suitable for use herein include films known under the trade reference PT film or the K-series of films supplied by Aicello, or VF-HP film supplied by Kuraray.

The enveloping material herein may comprise other additive ingredients than the polymer or polymer material and water. For example, it may be beneficial to add plasticisers, for example glycerol, ethylene glycol, diethyleneglycol, propylene glycol, dipropylene glycol, sorbitol and mixtures thereof. Preferably the enveloping material comprises glycerol as plasticisers. Other useful additives include disintegrating aids.

### Process for Making the Pouch

The process of the invention comprising the steps of:
i) making a first open compartment, the first open compartment is made with the water-soluble enveloping material, the enveloping material can be a film that is placed over a mould or the enveloping material can be injection moulded to form an open compartment, the open compartment is filled with the homogeneous free-flowing powder;
ii) optionally, but preferably, a second open compartment is made, similar to how the first open compartment is made, alternatively, the second open compartment can be made on top of the first open compartment, the second open compartment is filled with a liquid; and
iii) closing the open compartment(s) to make a pouch, each open compartment can be closed with enveloping material, for example a film, or with another closed compartment.

The pouches can be made using any known process in the art. For example, the pouches can be made using a water-soluble film as described in EP 1 504 994 A2. Alternatively, the pouches can be made using injection moulding as described in WO 02/092456 or by using a thermoforming process as described in EP 1 375 637 A1.

### Homogeneous Powder

A “homogeneous powder” is a powder having a uniform particle size distribution. Most of the components of the powder have similar particle size. Minors components that are present in very low levels (less than 5% by weight of the composition, preferably less than 2% by weight of the composition) could have different particle size but preferably all the components have similar particle size. Within the meaning of the present invention a “homogeneous powder” is a powder in which at least 80%, preferably at least 90% of the powder has a weight average particle size of from about 250 to about 850 μm with less than about 10% by weight of the particles below about 150 μm and less than about 5%, preferably less than 3% by weight of the particles above about 1180 μm.

### Method for Measuring Particle Size Distribution

This test method is used herein to determine the particle size distribution of the homogeneous free flowing powder and the highly water-soluble salt. The particle size distribution is measured by sieving the powder through a succession of sieves with gradually smaller dimensions. The weight of material retained on each sieve is then used to calculate a particle size distribution. This test is conducted to determine the Median Particle Size of the subject particle using ASTM D 502-89, “Standard Test Method for Particle Size of Soaps and Other Detergents”, approved May 26, 1989, with a further specification for sieve sizes used in the analysis. Following section 7, “Procedure using machine-sieving method,” a nest of clean dry sieves containing U.S. Standard (ASTM E 11) sieves #8 (2360 μm), #12 (1700 μm), #16 (1180 μm), 15 #20 (850 μm), #30 (600 μm), #40 (425 μm), #50 (300 μm), #70 (212 μm), and #100 (150 μm) is required. The prescribed Machine-Sieving Method is used with the above sieve nest. The homogeneous free flowing powder, or the highly water-soluble salt are used as the sample. A suitable sieve-shaking machine can be obtained from W. S. Tyler Company of Mentor, Ohio, U.S.A. The data are plotted on a semi-log plot with the micron size opening of each sieve plotted against the logarithmic abscissa and the 20 cumulative mass percent (Q3) plotted against the linear ordinate.

An example of the above data representation is given in ISO 9276-1:1998, “Representation of results of particle size analysis—Part 1: Graphical Representation”, Figure A.4. The “weight average” particle size used herein is the Median Weight Particle Size (Dw50) and it is defined as the abscissa value at the point where the cumulative weight percent is equal to 50 percent, and is calculated by a straight line interpolation between the data points directly above (a50) and below (b50) the 50% value using the following equation:

Dw50=10[Log(Da50)−(Log(Da50)−Log(Db5o))*(Qa5o−50%)/(Qa50−Qbso)]

where Qa50 and Qb50 are the cumulative weight percentile values of the data immediately above and below the 50th percentile, respectively; and Da50 and Db50 are the micron sieve size values corresponding to these data. In the event that the 50th percentile value falls below the finest sieve size (150 μm) or above the coarsest sieve size (2360 μm), then additional sieves must be added to the nest following a geometric progression of not greater than 1.5, until the median falls between two measured sieve sizes.

### Method for Measuring Cake Strength

Cake strength indicates the tendency that a particle has to cake and not flow freely. It is measured as described herein: a smooth plastic cylinder of internal diameter 63.5 mm and length 15.9 cm is supported on a suitable base plate. A 0.65 cm hole is drilled through the cylinder with the centre of the hole being 9.2 cm from the end opposite the base plate.

A metal pin is inserted through the hole and a smooth plastic sleeve of internal diameter 6.35 cm and length 15.25 cm is placed around the inner cylinder such that the sleeve can move freely up and down the cylinder and comes to rest on the metal pin. The space inside the sleeve is then filled (without tapping or excessive vibration) with the particulate material such that the particulate material is level with the top of the sleeve. A lid is placed on top of the sleeve and a 5 kg weight placed on the lid. The pin is then pulled out and the powder is allowed to compact for 2 minutes. After 2 minutes the weight is removed, the sleeve is lowered to expose the powder cake with the lid remaining on top of the powder.

A metal probe is then lowered at 54 cm/min such that it contacts the centre of the lid and breaks the cake. The maximum force required to break the cake is recorded and is the result of the test. A cake strength of ON refers to the situation where no cake is formed. The homogeneous free-flowing powder of the first compartment has a cake strength of less than 20 N, more preferably less than 10 N and especially less than 5N.

### Cohesive Powder

By “cohesive powder” is herein meant a powder having a particle size smaller than 100 μm. By a “particle size smaller than 100 μm” is meant that at least 80% and preferably at least 90% of the particles (by weight) have a particle size below 100 μm. The cohesive powder is in the form of secondary particle, preferably in the form of an agglomerate. Preferably, the composition of the invention comprises an iron chelant that is a cohesive powder. The iron chelant is preferably in the form of an agglomerate.

### Process for Making the Agglomerate

The process for making the agglomerate of the invention comprises the step of: a) providing the cohesive powder and the highly water soluble salt, preferably in powder form: b) adding water; and c) mixing the powders and water in a mixer or granulator that is operating at a suitable shear force for agglomeration to occur; (d) optionally, removing any oversize particles, which are recycled via a grinder or lump-breaker back into the process stream, e.g., into step (a) or (c); (e) the resulting agglomerates are dried to remove moisture that may be present in excess of 3 wt %, preferably in excess of 2%, and more preferably in excess of 1%; (f) optionally, removing any fines and recycling the fines to the mixer-granulator, as described in step (c); and (g) optionally, further removing any dried oversize agglomerates and recycling via a grinder to step (a) or (c).

### Highly Water-Soluble Salt

By “highly water-soluble salt” is herein understood a salt which has a solubility in water of more than 10, preferably more than 25 grams in 100 mls of water at 25° C. in less than 5 minutes when subjected to an agitation of 600 rpm.

Highly water-soluble salts include carbonate, sulfate and citrate. Preferably the composition of the invention is “substantially builder-free”. Citrate, preferably sodium citrate, is the preferred highly water-soluble salt to use herein.

A preferred agglomerate for use in the process of the invention comprises:
i) from about 10 to 40%, preferably from 20 to 30% by weight of the agglomerate of iron chelant, preferably disodium catecholdisulfonate;
ii) from about 20 to 60%, preferably from 30 to 60% by weight of the agglomerate of fine citrate having a weight average particle size of from about 212 to less than 425 μm; and
iii) from about 20 to 60%, preferably from 30 to 60% by weight of the agglomerate of coarse citrate having a weight average particle size of from greater than 425 to about 850 μm.

Agglomerates with the above composition are robust and fast dissolving. The process for making them is very efficient because only a small amount of water is required for the agglomeration to occur and consequently not much drying is needed thereby reducing the energy requirement of the process.

### Detergent Composition

The composition of the invention has a “low pH”, by a low pH composition is herein meant a composition having a pH of from about 5 to about 8 as measured in 1% weight aqueous solution (distilled water) at 25° C. In addition to good cleaning and shine, this pH is quite gentle on the washed items, it is not as aggressive as commonly used alkaline compositions and therefore keep washed items such as glasses, patterned ware, etc looking new for longer.

Preferably, the composition of the invention has a pH of from about 5 to about 6.9 as measured in 1% weight aqueous solution (distilled water) at 25° C. This pH provides even better cleaning and shine.

### Iron Chelant

The composition of the invention preferably comprises an iron chelant at a level of from about 0.1% to about 5%, preferably from about 0.2% to about 2%, more preferably from about 0.4% to about 1% by weight of the composition.

As commonly understood in the detergent field, chelation herein means the binding or complexation of a bi- or multi-dentate ligand. These ligands, which are often organic compounds, are called chelants, chelators, chelating agents, and/or sequestering agent. Chelating agents form multiple bonds with a single metal ion. Chelants form soluble, complex molecules with certain metal ions, inactivating the ions so that they cannot normally react with other elements or ions to produce precipitates or scale. The ligand forms a chelate complex with the substrate. The term is reserved for complexes in which the metal ion is bound to two or more atoms of the chelant.

The composition of the present invention is preferably substantially free of builders and preferably comprises an iron chelant. An iron chelant has a strong affinity (and high binding constant) for Fe(III).

It is to be understood that chelants are to be distinguished from builders. For example, chelants are exclusively organic and can bind to metals through their N,P,O coordination sites or mixtures thereof while builders can be organic or inorganic and, when organic, generally bind to metals through their O coordination sites. Moreover, the chelants typically bind to transition metals much more strongly than to calcium and magnesium; that is to say, the ratio of their transition metal binding constants to their calcium/magnesium binding constants is very high. By contrast, builders herein exhibit much less selectivity for transition metal binding, the above-defined ratio being generally lower.

The chelant in the composition of the invention is a selective strong iron chelant that will preferentially bind with iron (III) versus calcium in a typical wash environment where calcium will be present in excess versus the iron, by a ratio of at least 10:1, preferably greater than 20:1.

The iron chelant when present at 0.5 mM in a solution containing 0.05 mM of Fe(III) and 2.5 mM of Ca(II) will fully bind at least 50%, preferably at least 75%, more preferably at least 85%, more preferably at least 90%, more preferably at least 95%, more preferably at least 98% and specially at least 99% of the Fe(III) at one or preferably more of pHs 6.5 or 8 as measured at 25° C. The amount of Fe(III) and Ca(II) bound by a builder or chelant is determined as explained herein below

### Method for Determining Competitive Binding

To determine the selective binding of a specific ligand to specific metal ions, such as iron(III) and calcium (II), the binding constants of the metal ion-ligand complex are obtained via reference tables if available, otherwise they are determined experimentally. A speciation modeling simulation can then be performed to quantitatively determine what metal ion-ligand complex will result under a specific set of conditions.

As used herein, the term “binding constant” is a measurement of the equilibrium state of binding, such as binding between a metal ion and a ligand to form a complex. The binding constant K_{bc} (25° C. and an ionic strength (I) of 0.1 mol/L) is calculated using the following equation:

K_{bc}=[MLₓ]/([M][L]^{x})

where [L] is the concentration of ligand in mol/L, x is the number of ligands that bond to the metal, [M] is the concentration of metal ion in mol/L, and [MLₓ] is the concentration of the metal/ligand complex in mol/L.

Specific values of binding constants are obtained from the public database of the National Institute of Standards and Technology (“NIST”), R. M. Smith, and A. E. Martell, NIST Standard Reference Database 46, NIST Critically Selected Stability Constants of Metal Complexes: Version 8.0, May 2004, U.S. Department of Commerce, Technology Administration, NIST, Standard Reference Data Program, Gaithersburg, Md. If the binding constants for a specific ligand are not available in the database then they are measured experimentally.

Once the appropriate binding constants have been obtained, a speciation modeling simulation can be performed to quantitatively determine what metal ion-ligand complex will result under a specific set of conditions including ligand concentrations, metal ion concentrations, pH, temperature and ionic strength. For simulation purposes, NIST values at 25° C. and an ionic strength (I) of 0.1 mol/L with sodium as the background electrolyte are used. If no value is listed in NIST the value is measured experimentally. PHREEQC from the US Geological Survey, http://wwwbrr.cr.usgs.gov/projects/GWC_coupled/phreeqc/. PHREEQC is used for speciation modeling simulation.

Iron chelants include those selected from siderophores, catechols, enterobactin, hydroxamates and hydroxypyridinones or hydroxypyridine N-Oxides. Preferred chelants include anionic catechols, particularly catechol sulphonates, hydroxamates and hydroxypyridine N-Oxides. Preferred strong chelants include hydroxypridine N-Oxide (HPNO), Octopirox, and/or Tiron (disodium 4,5-dihydroxy-1,3-benzenedisulfonate), with Tiron, HPNO and mixtures thereof as the most preferred for use in the composition of the invention. HPNO within the context of this invention can be substituted or unsubstituted. Numerous potential and actual resonance structures and tautomers can exist. It is to be understood that a particular structure includes all of the reasonable resonance structures and tautomers.

### Liquid Composition

It is desirable to have liquid compositions with low viscosity. Low viscosity liquid compositions can be delivered into the pouch at higher speed than liquid compositions of higher viscosity. Preferred viscosities for the composition of the invention are in the range of from about 1 to about 500, more preferably from about 100 to about 300 mPa s determined according to DIN 53018-1:2008-09 at 23° C.

The liquid composition preferably has an eRH of about 65% or less as measured at 20° C., preferably about 60% or less, more preferably about 55% or less and more than about 30%. The pouch presents a good stability profile (including chemical stability of the cleaning composition and physical and mechanical stabilities of the enveloping material) and at the same time provides good cleaning.

Equilibrium relative humidity “eRH” measures the vapour pressure generated by the moisture present in a composition. It can be expressed as:

eRH=100×Aw
Wherein Aw is water activity:

Aw=p/ps, where:
p: partial pressure of water vapour at the surface of the composition.
ps: saturation pressure, or the partial pressure of water vapour above pure water at the composition temperature.

Water activity reflects the active part of moisture content or the part which, under the established conditions (20° C.), can be exchanged between a composition and its environment. For the purpose of this invention all the measurements are taken at atmospheric pressure unless stated otherwise.

The eRH of the liquid composition can be measured using any commercially available equipment, such as a water activity meter (Rotronic A2101).

Preferably the liquid composition comprises an aqueous solution of a lime soap dispersing agent, preferably, the liquid composition comprises more than 20% by weight of the liquid of aqueous solution comprising lime soap dispersing agent

### Other Detergent Ingredients

### Bleach

The composition of the invention preferably comprises less than about 10% bleach, more preferably less than 8% and especially from about 1 to about 5% bleach by weight of the composition.

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

### Crystal Growth Inhibitor

Crystal growth inhibitors are materials that can bind to calcium carbonate crystals and prevent further growth of species such as aragonite and calcite.

Examples of effective crystal growth inhibitors include phosphonates, polyphosphonates, inulin derivatives and cyclic polycarboxylates.

Suitable crystal growth inhibitors may be selected from the group comprising HEDP (1-hydroxyethylidene 1,1-diphosphonic acid), carboxymethylinulin (CMI), tricarballylic acid and cyclic carboxylates. For the purposes of this invention the term carboxylate covers both the anionic form and the protonated carboxylic acid form.

Cyclic carboxylates contain at least two, preferably three or preferably at least four carboxylate groups and the cyclic structure is based on either a mono- or bi-cyclic alkane or a heterocycle. Suitable cyclic structures include cyclopropane, cyclobutane, cyclohexane or cyclopentane or cycloheptane, bicyclo-heptane or bicyclo-octane and/or tetrhaydrofuran. One preferred crystal growth inhibitor is cyclopentane tetracarboxylate.

Cyclic carboxylates having at least 75%, preferably 100% of the carboxylate groups on the same side, or in the “cis” position of the 3D-structure of the cycle are preferred for use herein.

It is preferred that the two carboxylate groups, which are on the same side of the cycle are in directly neighbouring or “ortho” positions

Preferred crystal growth inhibitors include HEDP, tricarballylic acid, tetrahydrofurantetracarboxylic acid (THFTCA) and cyclopentanetetracarboxylic acid (CPTCA). The THFTCA is preferably in the 2c,3t,4t,5c-configuration, and the CPTCA in the cis,cis,cis,cis-configuration.

The crystal growth inhibitors are present preferably in a quantity from about 0.01 to about 10%, particularly from about 0.02 to about 5% and in particular from 0.05 to 3% by weight of the composition.

### Lime Soap Dispersing Agent

The composition of the invention comprises a lime soap dispersing agent, which has a lime soap dispersing power (LSDP), as defined hereinafter of no more than 25, preferably no more than 12, most preferably no more than 8. The lime soap dispersing is present at a level of from 0.1% to 40% by weight, more preferably 1% to 20% by weight, most preferably from 2% to 10% by weight of the compositions. In particular the lime soap dispersing agent is present in the liquid composition in a level of at least 20%, preferably at least 25% and less than 95% by weight of the liquid composition.

A lime soap dispersing agent is a material that prevents the precipitation of alkali metal, ammonium or amine salts of fatty acids by calcium or magnesium ions. A numerical measure of the effectiveness of a lime soap dispersing agent is given by the lime soap dispersing power (LSDP) which is determined using the lime soap dispersion test as described in an article by H. C. Borghetty and CA. Bergman, J. Am. Oil. Chem. Soc, volume 27, pages 88-90, (1950). This lime soap dispersion test method is widely used by practitioners in this art field being referred to, for example, in the following review articles; W. N. Linfield, Surfactant Science Series, Volume 7, p3; W. N. Linfield, Tenside Surf. Det., Volume 27, pages 159-161, (1990); and M. K. Nagarajan, W. F. Masler, Cosmetics and Toiletries, Volume 104, pages 71-73, (1989). The LSDP is the % weight ratio of dispersing agent to sodium oleate required to disperse the lime soap deposits formed by 0.025 g of sodium oleate in 30 ml of water of 333 ppm CaCO₃ (Ca:Mg=3:2) equivalent hardness.

In the Borghetty/Bergman lime soap dispersion test 5 ml of a 0.5% by weight solution of sodium oleate is added to a test tube, followed by 10 ml of a hard water solution containing 600 ppm Ca²⁺ and 400 ppm Mg²⁺ (1000 ppm as CaCO₃ equivalent, 70 Clark Hardness) which will cause formation of a lime soap deposit (or curd). An arbitrary amount (less than 15 ml) of dispersing agent as a 0.25% by weight solution is then added to the test tube. The total volume of solution in the test tube is then made up to 30 ml and the test tube is stoppered, inverted 20 times and then allowed to stand for 30 seconds. The contents of the test tube are then visually inspected to check if the lime soap deposits are still intact or whether they have been dispersed into the solution. The test procedure is repeated using different amounts of dispersing agent solution until the minimum amount of dispersing agent solution which will cause dispersion of the lime soap deposits is obtained.

The lime soap dispersing power is then obtained as:

LSDP=(weight of lime soap dispersing agent)×100/(weight of sodium oleate).

Thus in accord with the test method described above a material with a lower LSDP is a more weight effective lime soap dispersant than one with a higher LSDP.

A listing of suitable lime soap dispersants for use in accord with the invention is given in the above mentioned review by M. Linfield to be found in Tenside. Sust. Det., Volume 27, pages 159-161 (1990).

Polymeric lime soap dispersing agents suitable for use herein are described in the above mentioned article by M. K. Nagarajan and W. F. Masler, to be found in Cosmetics and Toiletries, Volume 104, pages 71-73, (1989). Examples of such polymeric lime soap dispersing agents and include certain water-soluble salts of copolymers of acrylic acid, methacrylic acid or mixtures thereof, and an acrylamide or substituted acrylamide, where such polymers typically have a molecular weight of from 5,000 to 20,000.

Surfactants having good lime soap dispersant capability will include certain amine oxides, betaines, sulfobetaines, alkyl ethoxysulfates and ethoxylated alcohols. Specially preferred lime soap dispersing agents are alkyl ethoxysulfates.

Exemplary surfactants having a LSDP of no more than 8 for use in accord with the invention include C16-C18 dimethyl amine oxide, C12-C18 alkyl ethoxysulfates with an average degree of ethoxylation of from 1-5, particularly C12-C15 alkyl ethoxysulfate surfactant with a degree of ethoxylation of about 3 (LSDP of about 4), and the C13-C15 ethoxylated alcohols with an average degree of ethoxylation of either 12 (LSDP of about 6) or 30, sold under the trade names Lutensol A012 and Lutensol A030 respectively, by BASF GmbH.

Preferred lime soap dispersing agents for use herein are selected from performance polymers, anionic surfactants and mixtures thereof

### Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C8-C 22 alkyl, or acyl group. Such surfactants are employed in the form of water-soluble salts and the salt-forming cation usually is selected from sodium, potassium, ammonium, magnesium and mono-, di- or tri-C 2-C 3 alkanolammonium, with the sodium cation being the usual one chosen.

The anionic surfactant can be a single surfactant or a mixture of anionic surfactants. Preferably the anionic surfactant comprises a sulphate surfactant, more preferably a sulphate surfactant selected from the group consisting of alkyl sulphate, alkyl alkoxy sulphate and mixtures thereof. Preferred alkyl alkoxy sulphates for use herein are alkyl ethoxy sulphates, preferably having an average alkoxylation degree (n) of from about 0.1 to about 8, 0.2 to about 5, even more preferably from about 0.3 to about 4, even more preferably from about 0.8 to about 3.5 and especially from about 1 to about 3.

Preferably the anionic surfactant for use herein is not purely based on a linear alcohol, but has some alcohol content that contains a degree of branching. Without wishing to be bound by theory it is believed that branched surfactant drives stronger starch cleaning, particularly when used in combination with an α-amylase, based on its surface packing.

Alkyl ether sulphates are commercially available with a variety of chain lengths, ethoxylation and branching degrees, examples are those based on Neodol alcohols ex the Shell company, Lial-Isalchem and Safol ex the Sasol company, natural alcohols ex The Procter & Gamble Chemicals Company.

Preferably, the alkyl ether sulfate is present from about 0.05% to about 20%, preferably from about 0.1% to about 10%, more preferably from about 1% to about 6%, and most preferably from about 2% to about 5% by weight of the composition.

### Non-Ionic Surfactants

Suitable for use herein are non-ionic surfactants, they can acts as anti-redeposition agents. Traditionally, non-ionic surfactants have been used in automatic dishwashing for surface modification purposes in particular for sheeting to avoid filming and spotting and to improve shine. It has been found that in the compositions of the invention, where filming and spotting does not seem to be a problem, non-ionic surfactants can contribute to prevent redeposition of soils.

Preferably, the composition comprises a non-ionic surfactant or a non-ionic surfactant system having a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Preferably non-ionic surfactants and/or system to use as anti-redeposition agents herein have a Draves wetting time of less than 360 seconds, preferably less than 200 seconds, more preferably less than 100 seconds and especially less than 60 seconds as measured by the Draves wetting method (standard method ISO 8022 using the following conditions; 3-g hook, 5-g cotton skein, 0.1% by weight aqueous solution at a temperature of 25° C.).

Amine oxides surfactants are also useful in the present invention as anti-redeposition surfactants. These amine oxide surfactants in particular include C₁₀-C₁₈ alkyl dimethyl amine oxides and C₈-C₁₈ alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C₁₀-C₁₈ alkyl dimethylamine oxide, and C₁₀₋₁₈ acylamido alkyl dimethylamine oxide.

Non-ionic surfactants may be present in amounts from 0 to 10%, preferably from 0.1% to 10%, and most preferably from 0.25% to 6% by weight of the composition.

### Suds Suppressor

Suds suppressors suitable for use herein include an alkyl phosphate ester suds suppressor, a silicone suds suppressor, or combinations thereof. Suds suppressor technology and other defoaming agents useful herein are documented in “Defoaming, Theory and Industrial Applications,” Ed., P. R. Garrett, Marcel Dekker, N.Y., 1973, incorporated herein by reference.

Suds suppressors are preferably included in the composition of the invention, especially when the composition comprises anionic surfactant. The suds suppressor is included in the composition at a level of from about 0.0001% to about 10%, preferably from about 0.001% to about 5%, more preferably from about 0.01% to about 1.5% and especially from about 0.01% to about 0.5%, by weight of the composition.

A preferred suds suppressor is a silicone based suds suppressor. A preferred silicone based suds suppressors is polydimethylsiloxanes having trimethylsilyl, or alternate end blocking units as the silicone. These may be compounded with silica and/or with surface-active non-silicon components, as illustrated by a suds suppressor comprising 12% silicone/silica, 18% stearyl alcohol and 70% starch in granular form. A suitable commercial source of the silicone active compounds is Dow Corning Corp. Silicone based suds suppressors are useful in that the silica works well to suppress the foam generated by the soils and surfactant

Another suitable silicone based suds suppressor comprises solid silica, a silicone fluid or a silicone resin. The silicone based suds suppressor can be in the form of a granule or a liquid.

Another silicone based suds suppressor comprises dimethylpolysiloxane, a hydrophilic polysiloxane compound having polyethylenoxy-propylenoxy group in the side chain, and a micro-powdery silica.

A phosphate ester suds suppressor may also be used. Suitable alkyl phosphate esters contain from 16-20 carbon atoms. Such phosphate ester suds suppressors may be monostearyl acid phosphate or monooleyl acid phosphate or salts thereof, preferably alkali metal salts.

Other suitable suds suppressors are calcium precipitating fatty acid soaps. However, it has been found to avoid the use of simple calcium-precipitating soaps as antifoams in the present composition as they tend to deposit on dishware. Indeed, fatty acid based soaps are not entirely free of such problems and the formulator will generally choose to minimize the content of potentially depositing antifoams in the instant composition.

### Enzyme-Related Terminology

### Nomenclature for Amino Acid Modifications

In describing enzyme variants herein, the following nomenclature is used for ease of reference:
Original amino acid(s):position(s):substituted amino acid(s).

According to this nomenclature, for instance the substitution of glutamic acid for glycine in position 195 is shown as G195E. A deletion of glycine in the same position is shown as G195*, and insertion of an additional amino acid residue such as lysine is shown as G195GK. Where a specific enzyme contains a “deletion” in comparison with other enzyme and an insertion is made in such a position this is indicated as *36D for insertion of an aspartic acid in position 36. Multiple mutations are separated by pluses, i.e.: S99G+V102N, representing mutations in positions 99 and 102 substituting serine and valine for glycine and asparagine, respectively. Where the amino acid in a position (e.g. 102) may be substituted by another amino acid selected from a group of amino acids, e.g. the group consisting of N and I, this will be indicated by V102N/I.

In all cases, the accepted IUPAC single letter or triple letter amino acid abbreviation is employed.

Where multiple mutations are employed they are shown with either using a “+” or a “/”, so for instance either S126C+P127R+S128D or S126C/P127R/S128D would indicate the specific mutations shown are present in each of positions 126, 127 and 128.

### Amino Acid Identity

The relatedness between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of an enzyme used herein (“invention sequence”) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity. An exact match occurs when the “invention sequence” and the “foreign sequence” have identical amino acid residues in the same positions of the overlap. The length of a sequence is the number of amino acid residues in the sequence.

### Protease

Preferred proteases for use herein have an isoelectric point of from about 4 to about 9, preferably from about 4 to about 8, most preferably from about 4.5 to about 6.5. Proteases with this isoelectric point present good activity in the wash liquor provided by the composition of the invention. As used herein, the term “isoelectric point” refers to electrochemical properties of an enzyme such that the enzyme has a net charge of zero as calculated by the method described below.

Preferably the protease of the composition of the invention is an endoprotease, by “endoprotease” is herein understood a protease that breaks peptide bonds of non-terminal amino acids, in contrast with exoproteases that break peptide bonds from their end-pieces.

### Isoelectric Point

The isoelectric point (referred to as IEP or pI) of an enzyme as used herein refers to the theoretical isoelectric point as measured according to the online pI tool available from ExPASy server at the following web address:
http://web.expasy.org/compute_pi/

The method used on this site is described in the below reference:
Gasteiger E., Hoogland C., Gattiker A., Duvaud S., Wilkins M. R., Appel R. D., Bairoch A.; Protein Identification and Analysis Tools on the ExPASy Server;
(In) John M. Walker (ed): The Proteomics Protocols Handbook, Humana Press (2005).

Preferred proteases for use herein are selected from the group consisting of a metalloprotease, a cysteine protease, a neutral serine protease, an aspartate protease and mixtures thereof.

### Metalloproteases

Metalloproteases can be derived from animals, plants, bacteria or fungi. Suitable metalloprotease can be selected from the group of neutral metalloproteases and Myxobacter metalloproteases. Suitable metalloproteases can include collagenases, hemorrhagic toxins from snake venoms and thermolysin from bacteria. Preferred thermolysin enzyme variants include an M4 peptidase, more preferably the thermolysin enzyme variant is a member of the PepSY˜Peptidase_M4˜Peptidase_M4_C family.

Preferred metalloproteases include thermolysin, matrix metalloproteinases and those metalloproteases derived from Bacillus subtilis, Bacillus thermoproteolyticus, Geobacillus stearothermophilus or Geobacillus sp., or Bacillus amyloliquefaciens, as described in US PA 2008/0293610A1. A specially preferred metalloprotease belongs to the family EC3.4.24.27.

Further suitable metalloproteases are the thermolysin variants described in WO2014/71410. In one aspect the metalloprotease is a variant of a parent protease, said parent protease having at least 50% or 60%, or 80%, or 85% or 90% or 95% or 96% or 97% or 98% or 99% or even 100% identity to SEQ ID NO: 3 of WO 2014/071410 including those with substitutions at one or more of the following sets of positions versus SEQ ID NO: 3 of WO 2014/071410:
(a) 2, 26, 47, 53, 87, 91, 96, 108, 118, 154, 179, 197, 198, 199, 209, 211, 217, 219, 225, 232, 256, 257, 259, 261, 265, 267, 272, 276, 277, 286, 289, 290, 293, 295, 298, 299, 300, 301, 303, 305, 308, 311 and 316;
(b) 1, 4, 17, 25, 40, 45, 56, 58, 61, 74, 86, 97, 101, 109, 149, 150, 158, 159, 172, 181, 214, 216, 218, 221, 222, 224, 250, 253, 254, 258, 263, 264, 266, 268, 271, 273, 275, 278, 279, 280, 282, 283, 287, 288, 291, 297, 302, 304, 307 and 312;
(c) 5, 9, 11, 19, 27, 31, 33, 37, 46, 64, 73, 76, 79, 80, 85, 89, 95, 98, 99, 107, 127, 129, 131, 137, 141, 145, 148, 151, 152, 155, 156, 160, 161, 164, 168, 171, 176, 180, 182, 187, 188, 205, 206, 207, 210, 212, 213, 220, 227, 234, 235, 236, 237, 242, 244, 246, 248, 249, 252, 255, 270, 274, 284, 294, 296, 306, 309, 310, 313, 314 and 315;
(d) 3, 6, 7, 20, 23, 24, 44, 48, 50, 57, 63, 72, 75, 81, 92, 93, 94, 100, 102, 103, 104, 110, 117, 120, 134, 135, 136, 140, 144, 153, 173, 174, 175, 178, 183, 185, 189, 193, 201, 223, 230, 238, 239, 241, 247, 251, 260, 262, 269, and 285;
(e) 17, 19, 24, 25, 31, 33, 40, 48, 73, 79, 80, 81, 85, 86, 89, 94, 109, 117, 140, 141, 150, 152, 153, 158, 159, 160, 161, 168, 171, 174, 175, 176, 178, 180, 181, 182, 183, 189, 205, 206, 207, 210, 212, 213, 214, 218, 223, 224, 227, 235, 236, 237, 238, 239, 241, 244, 246, 248, 249, 250, 251, 252, 253, 254, 255, 258, 259, 260, 261, 262, 266, 268, 269, 270, 271, 272, 273, 274, 276, 278, 279, 280, 282, 283, 294, 295, 296, 297, 300, 302, 306, 310 and 312;
(f) 1, 2, 127, 128, 180, 181, 195, 196, 197, 198, 199, 211, 223, 224, 298, 299, 300, and 316 all relative to SEQ ID NO: 3 of WO 2014/071410.

Further suitable metalloproteases are the NprE variants described in WO2007/044993, WO2009/058661 and US 2014/0315775. In one aspect the protease is a variant of a parent protease, said parent protease having at least 45%, or 60%, or 80%, or 85% or 90% or 95% or 96% or 97% or 98% or 99% or even 100% identity to SEQ ID NO:3 of US 2014/0315775 including those with substitutions at one or more of the following sets of positions versus said sequence:
S23, Q45, T59, S66, S129, F130, M138, V190, S199, D220, K211, and G222,

Another suitable metalloprotease is a variant of a parent protease, said parent protease having at least 60%, or 80%, or 85% or 90% or 95% or 96% or 97% or 98% or 99% or even 100% identity to SEQ ID NO:3 of US 2014/0315775 including those with substitutions at one or more of the following sets of positions versus SEQ ID NO:3 of US 2014/0315775:

Q45E, T59P, 566E, S129I, S129V, F130L, M138I, V190, S199E, D220P, D220E, K211V, K214Q, G222C, M138L/D220P, F130L/D220P, S129I/D220P, V190I/D220P, M138L/V190I/D220P, S129I/V190I, S129V/V190I, S129V/D220P, S129I/F130L/D220P, T004V/S023N, T059K/S66Q/S129I, T059R/S66N/S129I, S129I/F130L/M138L/V190I/D220P and T059K/S66Q/S129V.

Especially preferred metalloproteases for use herein belong belong to EC classes EC 3.4.22 or EC3.4.24, more preferably they belong to EC classes EC3.4.22.2, EC3.4.24.28 or EC3.4.24.27. The most preferred metalloprotease for use herein belong to EC3.4.24.27. Suitable commercially available metalloprotease enzymes include those sold under the trade names Neutrase® by Novozymes A/S (Denmark), the Corolase® range including Corolase® 2TS, Corolase® N, Corolase® L10, Corolase® LAP and Corolase® 7089 from AB Enzymes, Protex 14L and Protex 15L from DuPont (Palo Alto, Calif.), those sold as thermolysin from Sigma and the Thermoase range (PC10F and C100) and thermolysin enzyme from Amano enzymes.

The composition of the invention preferably comprises from 0.001 to 2%, more preferably from 0.003 to 1%, more preferably from 0.007 to 0.3% and especially from 0.01 to 0.1% by weight of the composition of active protease.

### Amylase

Amylases for use herein are preferably low temperature amylases. Compositions comprising low temperature amylases allow for a more energy efficient dishwashing processes without compromising in cleaning.

As used herein, “low temperature amylase” is an amylase that demonstrates at least 1.2, preferably at least 1.5 and more preferably at least 2 times the relative activity of the reference amylase at 25° C. As used herein, the “reference amylase” is the wild-type amylase of Bacillus licheniformis, commercially available under the tradename of Termamyl™ (Novozymes A/S). As used herein, “relative activity” is the fraction derived from dividing the activity of the enzyme at the temperature assayed versus its activity at its optimal temperature measured at a pH of 9.

Amylases include, for example, α-amylases obtained from Bacillus. Amylases of this invention preferably display some α-amylase activity. Preferably said amylases belong to EC Class 3.2.1.1.

Amylases for use herein, including chemically or genetically modified mutants (variants), are amylases possessing at least 60%, or 70%, or 80%, or 85%, or 90%, preferably 95%, more preferably 98%, even more preferably 99% and especially 100% identity, with those derived from Bacillus Licheniformis, Bacillus amyloliquefaciens, Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Suitable amylases include those derived from the sp. 707, sp. 722 or AA560 parent wild-types.

Preferred amylases include the variants of a parent amylase, said parent amylase having at least 60%, preferably 80%, more preferably 85%, more preferably 90%, more preferably 95%, more preferably 96%, more preferably 97%, more preferably 98%, more preferably 99% and specially 100% identity to SEQ ID NO:12 of WO2006/002643. The variant amylase preferably further comprises one or more substitutions and/or deletions in the following positions versus SEQ ID NO:12 of WO2006/002643:

9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484 and preferably the variant amylase comprises the deletions in one or both of the 183 and 184 positions.

Preferred amylases comprise one or both deletions in positions equivalent to positions 183 and 184 of SEQ ID NO:12 of WO2006/002643.

Preferred commercially available amylases for use herein are STAINZYME®, STAINZYME PLUS®, STAINZYME ULTRA®, EVEREST® and NATALASE® (Novozymes A/S) and RAPIDASE, POWERASE® and the PREFERENZ S® series, including PREFERENZ S100® (DuPont).

The composition of the invention preferably comprises from 0.001 to 2%, more preferably from 0.003 to 1%, more preferably from 0.007 to 0.3% and especially from 0.01 to 0.1% by weight of the composition of active amylase.

### Other Enzymes

Preferably the composition of the invention further comprises one or more enzymes selected from the group consisting of a (3-amylase, a pullulanase, a protease, a lipase, a cellulase, an oxidase, a phospholipase, a perhydrolase, a xylanase, a pectate lyase, a pectinase, a galacturanase, a hemicellulase, a xyloglucanase, a mannanase and a mixture thereof.

Suitable enzymes include X-Pect®, Mannaway®, Lipex®, Lipoclean®, Whitezyme®, Carezyme®, Celluzyme®, Carezyme Premium®, Celluclean® from Novozymes A/S and Purastar® and PrimaGreen® from DuPont.

### Example

### Abbreviations Used in the Example

In the example, the abbreviated component identifications have the following meanings:
Suds suppressor: GP-4314 powdered antifoam supplied by Dow Corning
Lutensol FP 620: Ethoxylated polyethyleneimine aqueous solution (80% active). Molecular weight 600. 20 ethoxy groups. Supplied by BASF.
Plurafac SLF180: Low foaming non-ionic surfactant supplied by BASF
Lutensol TO7 Non-ionic surfactant supplied by BASF
NaHEDP: Sodium salt of 1-hydroxyethylidene-1,1-diphosphonic acid
AES: Sodium C₁₂₋₁₄ alkyl ethoxy 3 sulfate aqueous paste (70% active)
DPG: Dipropylene glycol
Monosol M8630 Polyvinyl alcohol film supplied by Kuraray

In the following example the levels are quoted in grams.

A dual-compartment water-soluble pouch is made by firstly forming a first open compartment with Monosol M8630 film and filling the first open compartment with the powder composition exemplified below. A second open compartment is made with Monosol M8630 film, the compartment is filed with the liquid composition exemplified below, the second open compartment is closed and sealed with Monosol M8630 film and this second compartment is superposed over the first open compartment the two compartments are sealed to give to a dual compartment pouch.

| Material | Example 1 |
|---|---|
| | Powder (grams) |
| Agglomerate | 0.8 |
| Anhydrous citric acid | 0.73 |
| Subtilisin Protease | 0.4 |
| NaHEDP | 0.5 |
| Stainzyme Plus ® (14.4 mg/g) | 0.25 |
| Sodium Percarbonate | 0.5 |
| Suds suppressor | 0.02 |
| Sodium sulfate | 9.4 |
| | Liquid Phase (grams) |
| Lutensol FP 620 | 0.18 |
| DPG | 0.18 |
| Plurafac SLF180 | 0.34 |
| AES | 0.41 |
| Anhydrous citric acid | 0.05 |
| Glycerine | 0.33 |
| Dye | 0.02 |

### Agglomerate Composition

TABLE 1

| Material | Kg |
|---|---|
| Trisodium citrate dihydrate fine | 2 |
| Granular sodium citrate | 2 |
| CDS | 1 |
| Added water | 0.5 |

Trisodium citrate dihydrate fine: 370 μm weight average particle size
Trisodium citrate dihydrate coarse: 645 μm weight average particle size
CDS: Disodium Catecholdisulfonate supplied by from the FutureFuel® Chemical Company

An agglomerate, having the composition detailed in Table 1, was made in a Forberg 6 litre size batch paddle mixer. The powders were added to the mixer and the agitation commenced. The water was manually added from the top during a period of about 60 s. At the end of the mixing period, the wet product was emptied through the bottom of the mixer. Two batches of wet agglomerate (approx. 10 kg) were then placed in a Niro batch fluidised bed dryer. The drying was accomplished with hot air at 110° C. for 5 minutes.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a single or multi-compartment water-soluble cleaning pouch, the pouch comprising an enveloping material and a detergent composition, the detergent composition comprising a cohesive powder and having a low pH, the process comprising the steps of:
i) making a first open compartment and filling the first open compartment with a homogeneous free-flowing powder comprising the cohesive powder in the form of a secondary particle wherein at least 80% of the homogeneous free-flowing powder has a weight average particle size of from about 250 to about 850 μm with less than about 10% by weight of the particles below about 150 μm and less than about 5% by weight of the particles above about 1180 μm and wherein the powder has a cake strength of less than about 20 N;
ii) optionally making a second open compartment and filing the second open compartment with a liquid; and
iii) closing the open compartment(s) to make a pouch.

2. A process according to claim 1 wherein the cohesive powder is an iron chelant.

3. A process according to claim 1 wherein the secondary particle is an agglomerate comprising:
i) the cohesive powder; and
ii) a highly water-soluble salt.

4. A process according to claim 1 wherein at least 80% of the cohesive powder has a particle size below 100 μm.

5. A process according to claim 1 wherein the cohesive powder is an iron chelant selected from the group consisting of siderophores, catechols, enterobactin, hydroxamates, hydroxypyridinones (or hydroxypyridine N-Oxides) and mixtures thereof.

6. A process according to claim 1 wherein the wherein the cohesive powder is an iron chelant comprising a catechol sulfonate.

7. A process according to claim 1 wherein the cohesive powder is an iron chelant comprising a hydroxypyridine N-Oxide.

8. A process according to claim 1 wherein the cohesive powder is an iron chelant and the detergent composition comprises from about 0.1% to about 5% by weight of the composition of iron chelant.

9. A process according to claim 1 wherein the secondary particle is an agglomerate comprising:
i) the cohesive powder; and
ii) a highly water-soluble salt.
wherein the highly water soluble salt is citrate.

10. A process according to claim 1 wherein the secondary particle is an agglomerate comprising:
i) the cohesive powder; and
ii) a highly water-soluble salt.
wherein the agglomerate is made by admixing the cohesive powder with the highly water-soluble salt and with less than 20% by weight of the agglomerate of water and wherein the highly water soluble salt comprises is a mixture of two different particle sizes.

11. A process according to claim 1 wherein the secondary particle is an agglomerate comprising:
i) from about 10 to 40% by weight of the agglomerate of iron chelant;
ii) from about 20 to 60% by weight of the agglomerate of fine citrate having a weight average particle size of from about 212 to less than 425 μm; and
iii) from about 20 to 60% by weight of the agglomerate of coarse citrate having a weight average particle size of from greater than 425 to about 850 μm.

12. A process according to claim 1 wherein the liquid in the second compartment comprises an aqueous lime soap dispersing agent.

13. A process according to claim 1 wherein the liquid has a viscosity of from about 1 to about 500 m Pa s at 23° C.

14. A process according to claim 1 wherein the liquid has eRH of less than about 60% at about 20° C.

15. A single or multi-compartment water-soluble detergent pouch obtainable according to the process of claim 1.
